(19) United States
(12) Patent Application Publication
(10) Pub. No.: US 2024/0266087 A1
(43) Pub. Date: Aug. 8, 2024

(54) WIRE HARNESS

(71) Applicant: Proterial, Ltd., Tokyo (JP)

(72) Inventors: Hirotaka ESHIMA, Tokyo (JP); Shingo HATAYAMA, Tokyo (JP); Yoshikazu HAYAKAWA, Tokyo (JP); Takahiro FUTATSUMORI, Tokyo (JP)

(21) Appl. No.: 18/422,298

(22) Filed: Jan. 25, 2024

(30) Foreign Application Priority Data
Feb. 3, 2023 (JP) 2023-015152

(51) Int. Cl. H01B 7/40; B60R 16/02; H01B 7/00

(52) U.S. Cl. CPC H01B 7/40; B60R 16/0215; H01B 7/0045

(57) ABSTRACT

A wire harness is provided with a plurality of electric wires, a sheath covering the plurality of electric wires together, a tubular elastic member disposed around the sheath, a tightening member for tightening one part of the elastic member to secure the elastic member and the sheath to an attachment object, a cover having a gripping portion for gripping another part of the elastic member, a first guide portion for guiding some of the plurality of electric wires in a first direction, and a second guide portion for guiding some other of the plurality of electric wires in a second direction that is different from the first direction.

### CROSS-REFERENCE TO RELATED APPLICATIONS

The present patent application claims the priority of Japanese patent application No. 2023-015152 filed on Feb. 3, 2023, and the entire contents thereof are hereby incorporated by reference.

### TECHNICAL FIELD

This invention relates to a wire harness having multiple electric wires.

### BACKGROUND OF THE INVENTION

Conventionally, wiring harnesses having multiple electric wires have been used, for example, for wiring an electrical system in a vehicle. Patent Literature 1 describes a composite harness in which a cable for an ABS sensor and a cable for a parking brake are housed inside a sheath. This composite harness has a molded portion covering the vicinity of the end of the sheath. The molded portion has a water sealing portion that branches the cable for the ABS sensor and the cable for the parking brake in different draw directions and also stops water at the end of the sheath, and a bracket attachment portion for attaching a bracket, and the water sealing portion and the bracket attachment portion are integrally molded from urethane.

Citation List Patent Literature 1: JP2020-80304A

### SUMMARY OF THE INVENTION

In the wire harness of Patent Literature 1, when molding the molded portion, the sheath, the cable for the ABS sensor, and the cable for the parking brake are placed in a mold in a predetermined positional relationship, the mold is clamped, and molten urethane resin is injected into the mold to perform molding. In this case, the need arises to consider the heat during molding for the materials of the cable for the ABS sensor, the cable for the parking brake, and the sheath when manufacturing the wire harness. That is, there are restrictions on the selection of materials to prevent damage to each cable and sheath due to the heat of the molten urethane resin, etc.

Therefore, it is an object of the present invention to provide a wire harness capable of reducing the need to consider heat during manufacturing.

For solving the above problem, one aspect of the present invention provides a wire harness comprising a plurality of electric wires;
a sheath covering the plurality of electric wires together;
a tubular elastic member disposed around the sheath;
a tightening member for tightening one part of the elastic member to secure the elastic member and the sheath to an attachment object;
a cover having a gripping portion for gripping another part of the elastic member, a first guide portion for guiding some of the plurality of electric wires in a first direction, and a second guide portion for guiding some other of the plurality of electric wires in a second direction that is different from the first direction.

### Effects of the Invention

According to the wire harnesses of the present invention, it is possible to reduce the need to consider heat during manufacturing, compared to molding multiple electric wires drawn in different directions together with the ends of the sheath to cover them all at once.

### BRIEF DESCRIPTION OF DRAWINGS

FIG. 1 is a perspective view showing a part of a wire harness according to an embodiment of the present invention.

FIG. 2A is a configuration diagram showing the inside of the cover with one cover member removed from a pair of cover members.

FIG. 2B is a configuration diagram showing the inside of the cover with the other cover member removed from the pair of cover parts.

FIG. 3 is a perspective view showing a pair of cover members.

FIG. 4 is a cross-sectional view along a line A-A in FIG. 1.

FIG. 5 is a cross-sectional view along a line B-B in FIG. 1.

FIG. 6 is a cross-sectional view along a line C-C in FIG. 1.

FIG. 7 is a cross-sectional view along a line D-D in FIG. 1.

FIG. 8 is a cross-sectional view along a line E-E in FIG. 1.

FIG. 9 is a cross-sectional view along a line F-F in FIG. 1.

FIG. 10A is a perspective view showing a single rubber tube according to a first modified example.

FIG. 10B is a cross-sectional view of the rubber tube along axial direction according to the first modified example.

FIG. 11A is a perspective view showing a single rubber tube according to a second modified example.

FIG. 11B is a cross-sectional view of the rubber tube along axial direction according to the second modified example.

### DETAILED DESCRIPTION OF THE INVENTION

### Embodiment

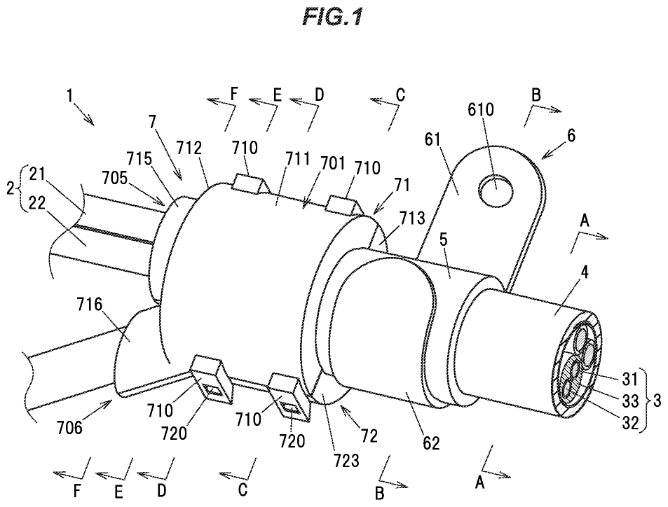

FIG. 1 is a perspective view showing a part of a wire harness 1 according to an embodiment of the present invention. The wire harness 1 includes a first cable 2 and a second cable 3, a sheath 4 that covers the first cable 2 and the second cable 3 together, a rubber tube 5 as a tubular elastic member arranged around the sheath 4, and a bracket 6 and cover 7. The sheath 4 is hollow tubular, and the first cable 2 and the second cable 3 are led out of the sheath 4 inside the cover 7.

The bracket 6 is a tightening member for fastening the sheath 4 and rubber tube 5 to a mounting target by tightening one part of the rubber tube 5. The mounting target is, for example, an unsprung (i.e., below-spring) member around a wheel, such as a hub or knuckle of a vehicle. The cover 7 comprises a pair of cover members 71, 72 that sandwich the rubber tube 5 in a radial direction of the cover 7, and are provided along the longitudinal direction of the sheath 4 and the rubber tube 5, alongside and apart from the bracket 6.

As an example, the first cable 2 is a parking brake cable for supplying operating power to an electric parking brake device of a vehicle and has a pair of power lines (i.e., power electric wires) 21, 22. The pair of power lines 21, 22 are in contact with each other. The second cable 3 is, as an example, a cable for an ABS sensor that transmits the detection signal of an ABS (anti-lock brake system) sensor and has a pair of signal lines (i.e., signal electric wires) 31, 32 and an inner sheath 33 that covers the pair of signal lines 31, 32. The pair of signal lines 31, 32 are twisted together in contact with each other. The inner sheath 33 enters the valley created by the pair of signal lines 31, 32 contacting each other. The sheath 4 and an inner sheath 33 are made of, for example, urethane. The inner sheath 33 may be omitted and the second cable 3 may be constituted by the pair of signal lines 31, 32.

The first cable 2 and the second cable 3 are twisted together with the pair of power lines 21, 22 and the inner sheath 33 in contact with each other. Between the first cable 2 and the second cable 3 and the sheath 4, a tape 8 wrapped around the outer-periphery of the first cable 2 and the second cable 3 is provided. The tape 8 is in contact with the first cable 2, the second cable 3, and the sheath 4.

The rubber tube 5 is made of a softer material than the sheath 4 and is cylindrical. EPDM (ethylene-propylene-diene copolymerized rubber), for example, is a suitable material for the rubber tube 5. The inner diameter of the rubber tube 5 is equivalent to the outer diameter of the sheath 4, and the sheath 4 is inserted into the rubber tube 5 so that no large gap is formed between the inner surface of the rubber tube 5 and the outer surface of the sheath 4. The rubber tube 5 is tightened to the bracket 6 in one part of the longitudinal direction and gripped by the cover 7 in the other part of the longitudinal direction. The rubber tube 5 may be bonded to the sheath 4. The rubber tube 5 may be molded integrally with the sheath 4, such as by injection molding the rubber material into the sheath 4.

The rubber tube 5 is attached to the cable 3 by inserting the cable 3 into the rubber tube 5 (in the axial direction of the rubber tube 5). However, the rubber tube 5 may be attached to the cable 3 by forming a slit across the longitudinal direction of the rubber tube 5 and inserting the cable 3 through the slit (in the direction that intersects the axial direction of the rubber tube 5 (radial direction)). That is, the above-mentioned cylinder includes not only a cylinder without a slit but also a cylinder with a slit. The rubber tube 5 may not only be cylindrical but may also be a polygonal cylinder with insertion holes formed in it.

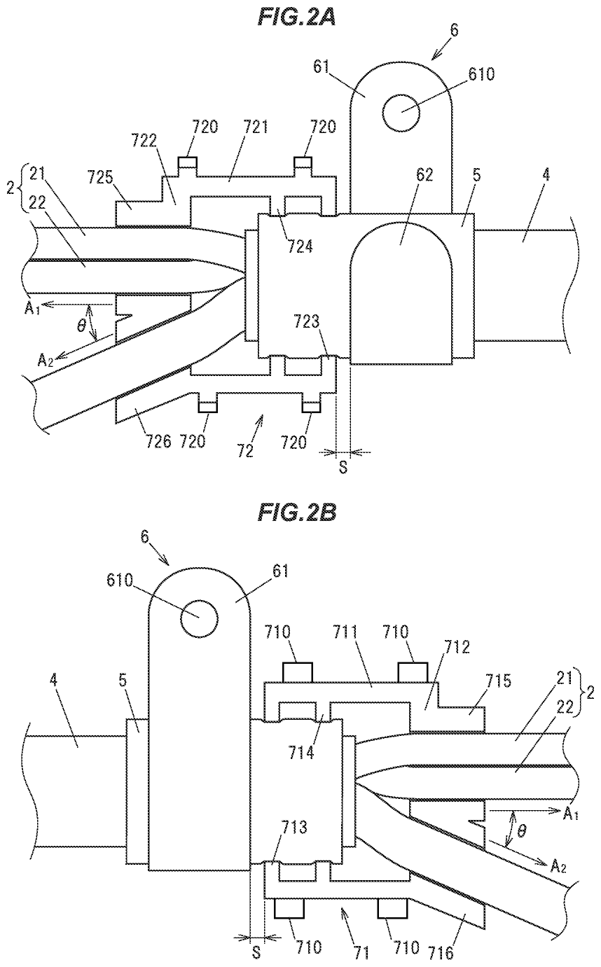

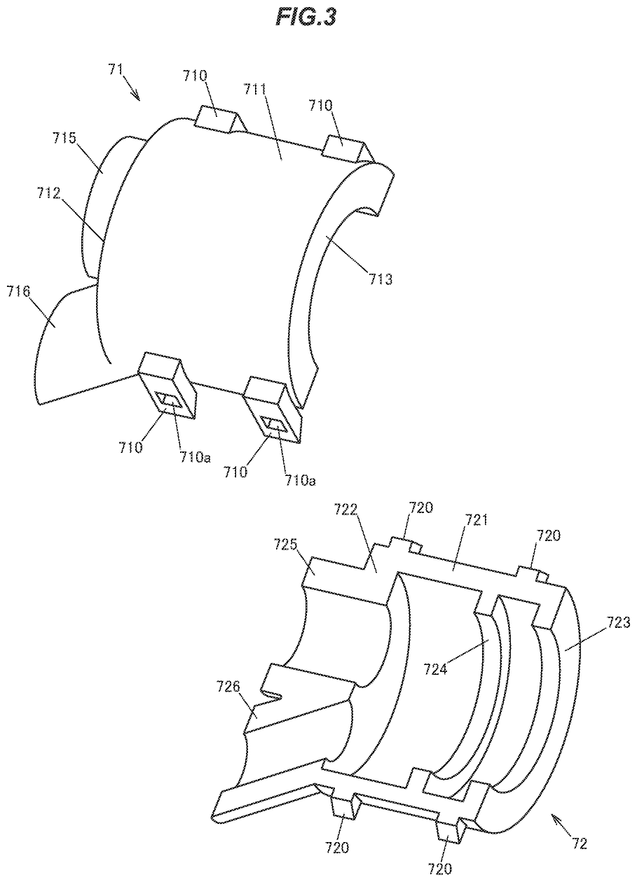

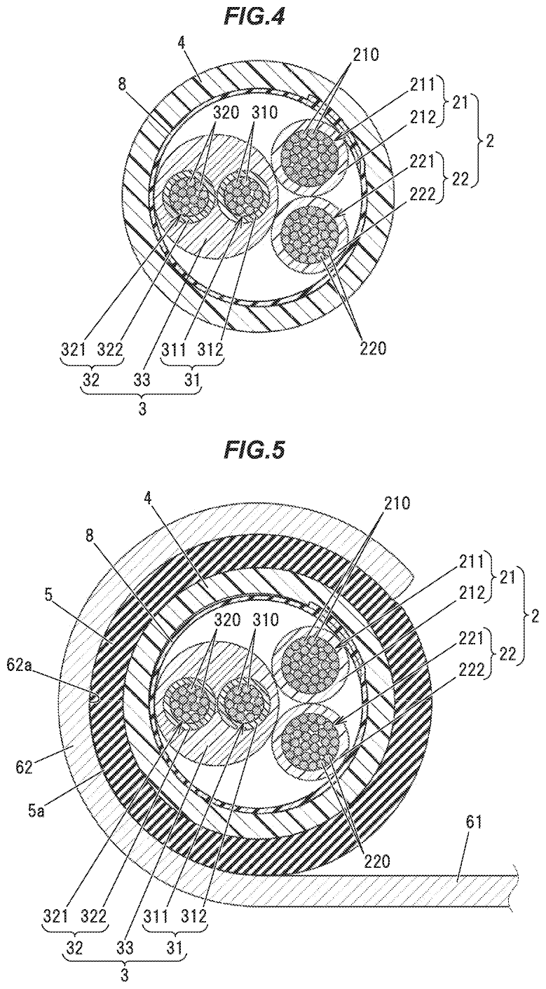

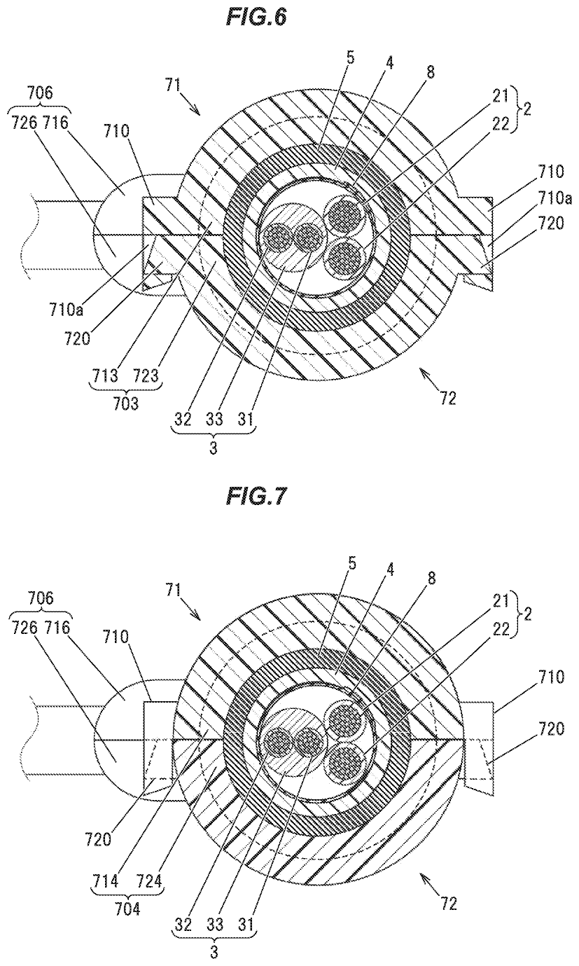

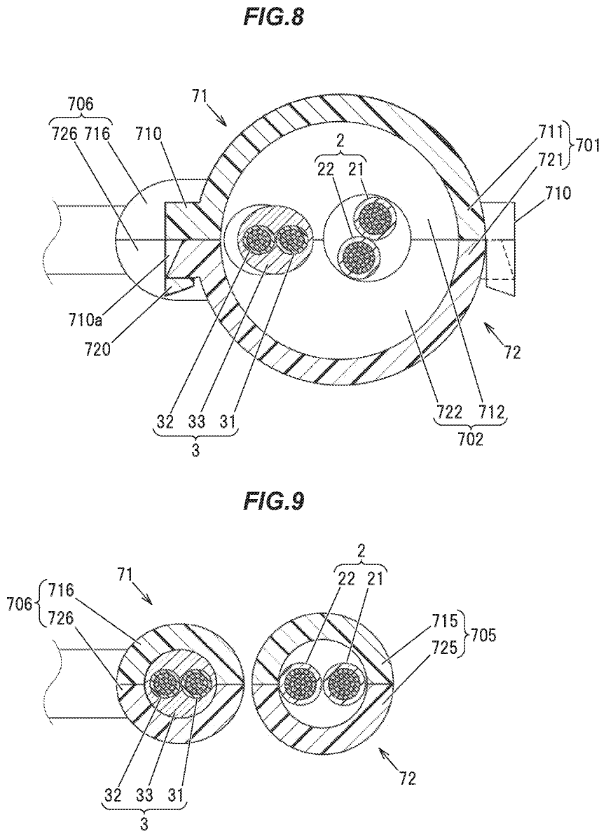

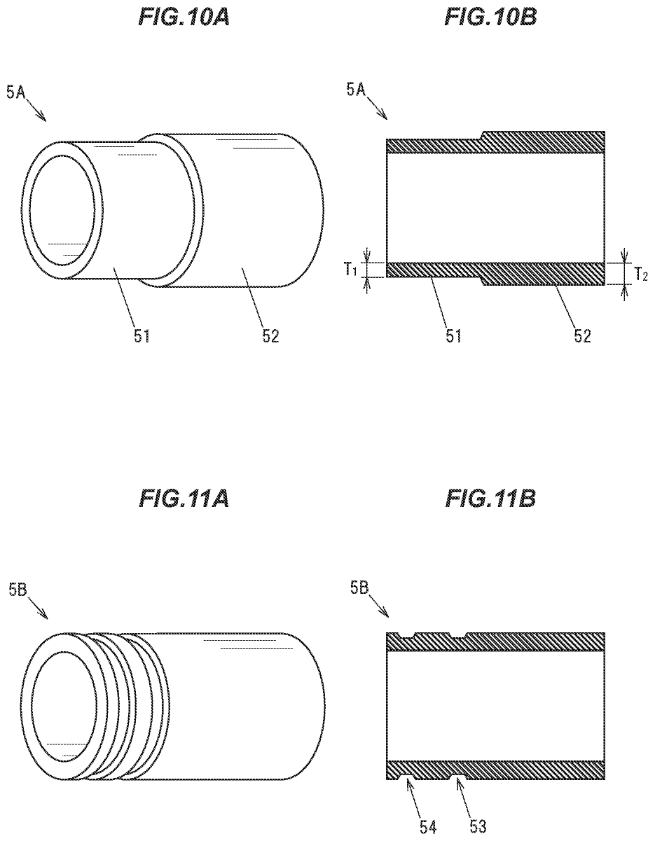

FIG. 2A is a configuration view of the interior of the cover 7 with one of the pair of the cover members 71, 72 of the cover 7 removed. FIG. 2B is a configuration view showing the inside of the cover 7 with the other cover member 72 of the pair of cover members 71, 72 of the cover 7 removed. FIG. 3 is a perspective view showing a pair of cover members 71, 72. FIG. 4 is a cross-sectional view along a line A-A in FIG. 1. FIG. 5 is a cross-sectional view along a line B-B in FIG. 1. FIG. 6 is a cross-sectional view along a line C-C in FIG. 1. FIG. 7 is a cross-sectional view along a line D-D in FIG. 1. FIG. 8 is a cross-sectional view along a line E-E in FIG. 1. FIG. 9 is a cross-sectional view along a line F-F in FIG. 1.

As shown in FIGS. 2A and B, the spacing S between bracket 6 and cover 7 along longitudinal direction of rubber tube 5 is, for example, from 1 mm to 10 mm. If the spacing S is smaller than 1 mm, the bracket 6 and cover 7 are more likely to interfere with each other. If the spacing S is smaller than 10 mm, the installation space for the wiring harness 1 becomes larger.

As shown in FIGS. 4 and 5, the power lines 21, 22 of the first cable 2 are insulation-coated electric wires, respectively, having core wires 211, 221 consisting of multiple conductor strands 210, 220 twisted together, and insulation coatings 212, 222 covering the core wire 211, 221. The signal lines 31, 32 of the second cable 3 are insulation-coated electric wires, respectively, having core wires 311, 321 consisting of multiple conductor strands 310, 320 twisted together, and insulation coatings 312, 322 covering the core wires 311, 321, and are smaller in diameter than the power lines 21, 22.

As shown in FIGS. 6 to 9, the cover 7 is a combination of the pair of cover members 71, 72, collectively comprising a cylindrical base 701 having an inner diameter larger than the outer diameter of the rubber tube 5, a wall 702 provided inside one end of the base 701, circular first and second gripping parts 703, 704 that grip a part of the rubber tube 5, a cylindrical first guide 705 that guides the first cable 2 in a first direction, and a cylindrical second guide 706 that guides the second cable 3 in a second direction different from the first direction. The cover members 71, 72 are made of a harder material than the rubber tube 5, such as PA (polyamide) or PBT (polybutylene terephthalate).

In FIGS. 2A and 2B, the first direction is indicated by arrow A1 and the second direction is indicated by arrow A2. The first direction is parallel to the rubber tube 5 and the second direction intersects the first direction at an acute angle. The angle θ between the first direction and the second direction is not limited to an acute angle but can be a right angle or an obtuse angle. The first direction is the direction in which the first cable 2 goes from the cover 7 toward the electric parking brake device to be connected. The second direction is the direction of the second cable 3 from the cover 7 toward the ABS sensor to be connected. Wiring work during vehicle assembly can be performed easily by guiding the first cable 2 and the second cable 3 toward their respective connection targets.

Of the pair of cover members 71, 72, one cover member 71 is provided with multiple lock pieces 710 and the other cover member 72 is provided with multiple lock protrusions 720. Each of the multiple locking pieces 710 has a locking hole 710A, and the locking protrusions 720 are locked to the locking pieces 710 by mating the locking protrusions 720 into the locking holes 710A. For convenience of explanation, one cover member 71 is hereinafter referred to as the upper cover member 71 and the other cover member 72 as the lower cover member 72. The upper cover member 71 and the lower cover member 72 are coupled together by the multiple locking protrusions 720 of the lower cover member 72 being locked with the multiple locking pieces 710 of the upper cover member 71.

The base 701 of the cover 7 is formed by combining a half-split cylindrical portion 711 of the upper cover member 71 and a half-split cylindrical portion 721 of the lower cover member 72. The wall 702 of the cover 7 is formed by combining the half-disk portion 712 of the upper cover member 71 and the half-disk portion 722 of the lower cover member 72. The first gripping portion 703 of the cover 7 is formed by combining the first semicircular projection 713 of the upper cover member 71 and the first semicircular projection 723 of the lower cover member 72. The second gripping portion 704 of the cover 7 is formed by combining the second semicircular projection 714 of the upper cover member 71 and the second semicircular projection 724 of the lower cover member 72. The first guide 705 of the cover 7 is formed by combining the first semi-cylindrical portion 715 of the upper cover member 71 and the first semi-cylindrical portion 725 of the lower cover member 72. The second guide 706 of the cover 7 is formed by combining the second semi-cylindrical portion 716 of the upper cover member 71 and the second semi-cylindrical portion 726 of the lower cover member 72.

The first guide 705 and the second guide 706 are provided through the wall 702 and projecting from the wall 702. The first and second gripping portions 703, 704 are provided inside the base 701 and are spaced apart and aligned in the axial direction of the rubber tube 5. The first and second gripping portions 703, 704 have an inner diameter smaller than the outer diameter of the rubber tube 5 in its natural state, and tighten and grip the rubber tube 5 in the direction of its thickness. The natural state refers to the state in which no external force is applied to the rubber tube 5. The rubber tube 5 in its natural state is thicker than the sheath 4. The rubber tube 5 in its natural state is a simple cylindrical shape with no irregularities and uniform inner and outer diameters throughout its longitudinal direction. The fact that the cover 7 has multiple gripping portions (first and second gripping portions 703, 704) makes it possible, for example, to prevent the cover 7 from moving in the axial direction of the rubber tube 5 and becoming detached from the rubber tube 5. If sufficient gripping force can be obtained, there may be only one gripping portion.

The bracket 6 has a mounting portion 61 that is attached to a mounting object and a tightening portion 62 that tightens and holds the rubber tube 5. The bracket 6 is made of a single metal plate, and the mounting portion 61 and the tightening portion 62 are formed integrally. The mounting portion 61 is a flat plate with a mounting hole 610 formed through it in the direction of thickness. The tightening portion 62 is curved so that an inner circumferential surface 62a contacts the outer-peripheral surface 5a of the rubber tube 5 and surrounds part of the rubber tube 5.

Although the cover 7 does not have a waterproof structure in this model, it may be made waterproof by adding a sealing member such as an O-ring, for example, or by injecting a gel-like water sealing material inside the cover 7.

(Functions and effects of the embodiment)

According to the above embodiment, since the wiring harness 1 is manufactured by attaching the pre-molded rubber tube 5 and the cover 7, the need for molding during manufacturing is reduced and the need to consider heat during manufacturing can be reduced. According to the above embodiment, the wiring harness 1 can be configured and manufactured at low cost with a small number of parts and without molding. The bracket 6 and cover 7 are not directly attached to the sheath 4 but are mounted on the sheath 4 via rubber tube 5. This makes it possible to reduce damage to the sheath 4 and the first cable 2 and second cable 3 inside the sheath 4. That is, when the bracket 6 and the cover 7 are mounted directly in contact with the outer-periphery of the sheath 4, the sheath 4 itself and the first cable 2 and second cable 3 within the sheath 4 are subjected to strong tightening forces of the bracket 6 and gripping forces of the cover 7, which can easily cause damage, but according to the above embodiment, the tightening force of the bracket 6 and the gripping force of the cover 7 acting on the sheath 4 are mitigated by the rubber tube 5, thus preventing the occurrence of damage.

### First Modified Example

FIG. 6A is a perspective diagram of the rubber tube 5A for the first modified example as a stand-alone unit. FIG. 6B is a cross-sectional view of the rubber tube 5A along the axial direction. The rubber tube 5A has a uniform inner diameter throughout its longitudinal direction, but the small-diameter portion 51, including portions gripped by the first and second gripping portions 703, 704 of the cover 7, has a smaller outer diameter than the large-diameter portion 52, including portion tightened to the tightening portion 62 of the bracket 6. The thickness T1 of the small-diameter portion 51 is thicker than the thickness of the sheath 4 and thinner than the thickness T2 of the large-diameter portion 52. According to this rubber tube 5A, it is possible to reduce the diameter of the base 701 of the cover 7 according to the difference in outer diameter between the small-diameter portion 51 and the large-diameter portion 52 while securely holding the rubber tube 5A by the bracket 6.

### Second Modified Example

FIG. 7A is a perspective view of the rubber tube 5B for the second modified example as a stand-alone unit. FIG. 7B is a cross-sectional view of the rubber tube 5B along the axial direction. The rubber tube 5B has a first recess 53 formed in the portion gripped by the first gripping portion 703 of the cover 7 and a second recess 54 formed in the portion gripped by the second gripping portion 704 of the cover 7. The outer diameters of the rubber tube 5B other than portions where the first and second recesses 53, 54 are formed are larger than the inner diameters of the first and second gripping portions 703, 704, and the first and second gripping portions 703, 704 engage the first and second recesses 53, 54 of the rubber tube 5B to grip the rubber tube 5B. By using this rubber tube 5B, the axial misalignment of the rubber tube 5B to the cover 7 can be suppressed compared with the rubber tube 5 of the above embodiment.

### SUMMARY OF THE EMBODIMENTS AND MODIFICATIONS

Next, the technical concepts that can be grasped from the above embodiments and modifications are described with the help of the characters, etc. in the embodiments and modifications. However, each character in the following description does not limit the components in the scope of claims to the parts, etc. specifically shown in the embodiments.

According to the first feature, a wire harness 1 includes multiple electric wires. 21, 22, 31, 32, a sheath 4 covering the multiple electric wires. 21, 22, 31, 32 together, a tubular elastic member (rubber tube) 5, 5A, 5B arranged around the sheath 4, a tightening member (bracket) 6 for tightening one part of the elastic member 5, 5A, 5B to fix the elastic member (rubber tube) 5, 5A, 5B and the sheath 4 to an object to be mounted, a cover 7 having a gripping portion 703, 704 for gripping another portion of the elastic member 5, 5A, 5B, a first guide 705 that guides some electric wires 21, 22 of the multiple electric wires 21, 22, 31, 32 in the first direction, and a second guide for guiding other electric wires 31,33 in a second direction that is different from the first direction.

According to the first feature, in the harness 1 as described by the first feature, the tightening member 6 and the cover 7 are spaced apart in the longitudinal direction of the sheath 4.

According to the first feature, in the harness 1 as described by the first feature, the sheath 4 is hollow tubular and the elastic members 5, 5A, 5B are thicker than the sheath 4.

According to the first feature, in the harness 1 as described by the first feature, the cover 7 comprises a pair of cover members 71, 72 which sandwich the elastic members 5, 5A, 5B in the radial direction of the cover 7.

According to the first feature, in the harness 1 as described by the first feature, in the elastic member 5A, a thickness T₁ of a portion (small-diameter portion) 51 gripped by the gripping portion 703, 704 of the cover is thinner than a thickness T₂ of a portion (large-diameter portion) 52 tightened by the tightening member 6.

According to the first feature, in the harness 1 as described by the first feature, the elastic member 5B has a recess 53, 54 formed in a portion gripped by the gripping portion 703, 704 of the cover 7.

The above embodiments and modifications of the invention do not limit the invention as in the claims. It should also be noted that not all of the combinations of features described in the embodiments and modifications are essential to the means for solving the problems of the invention. The above description of the embodiment of the invention does not limit the invention as claimed above. It should also be noted that not all of the combinations of features described in the embodiment are essential to the means for solving the problems of the invention. In addition, the invention can be implemented with appropriate modifications to the extent that it does not depart from the gist of the invention.

1. A wire harness, comprising:
a plurality of electric wires;
a sheath covering the plurality of electric wires together;
a tubular elastic member disposed around the sheath;
a tightening member for tightening one part of the elastic member to secure the elastic member and the sheath to an attachment object;
a cover having a gripping portion for gripping another part of the elastic member, a first guide portion for guiding some of the plurality of electric wires in a first direction, and a second guide portion for guiding some other of the plurality of electric wires in a second direction that is different from the first direction.

2. The wire harness according to claim 1, wherein the tightening member and the cover are spaced apart in a longitudinal direction of the sheath.

3. The wire harness according to claim 1, wherein the sheath is hollow tubular, and wherein the elastic member is thicker than the sheath.

4. The wire harness according to claim 1, wherein the cover comprises a pair of cover members that sandwich the elastic member in a radial direction of the cover.

5. The wire harness according to claim 1, wherein, in the elastic member, a thickness of a portion gripped by the gripping portion of the cover is thinner than a thickness of a portion tightened by the tightening member.

6. The harness of claim 1, wherein the elastic member has a recess formed in a portion gripped by the gripping portion of the cover.
